(19) United States
(12) Patent Application Publication
(10) Pub. No.: US 2025/0051683 A1
(43) Pub. Date: Feb. 13, 2025

(54) Novel Process for Oil Seed Extraction and De-Oiled Oil Seed Flour Production

(71) Applicant: Louis Dreyfus Company Plant Proteins LLC, Livermore, CA (US)

(72) Inventors: Manoj Kumar, Livermore, CA (US); Prasanth Kumar Sasidharan Pillai, Livermore, CA (US)

(73) Assignee: Louis Dreyfus Company Plant Proteins LLC, Livermore, CA (US)

(21) Appl. No.: 18/792,381

(22) Filed: Aug. 1, 2024

Related U.S. Application Data
(60) Provisional application No. 63/532,307, filed on Aug. 11, 2023.

(51) Int. Cl. C11B 1/10; A23L 25/00

(52) U.S. Cl. CPC C11B 1/10; A23L 25/30

(57) ABSTRACT

Provided herein are processes for separating seed oil from seed flour that is economical and produces a de-oiled flour that maintains the native form of proteins in the flour.

### CROSS-REFERENCE

This application claims benefit of U.S. Provisional Patent Application No. 63/532,307 filed Aug. 11, 2023, which application is incorporated herein by reference in its entirety.

### BACKGROUND OF THE INVENTION

Oil seeds, such as rapeseed/canola and sunflower seeds, have long been a source of oils for culinary applications, as well as for use in cosmetics and a variety of industrial applications. Recent trends toward the use of vegetable proteins to replace animal-derived protein has created a significant demand for the production of plant protein products with unique and desirable qualities, particularly for use in foods meant to replace animal-based products. Seed-derived proteins have become a coveted source for producing nutritionally-enhanced products and meat and dairy substitutes with preferred textural appeal and varied functionalities. Therefore, an improved process for extracting oil from seeds that is both economical and produces a de-oiled flour that has desirable physical properties for use in plant-based foods and products is needed.

The separation of oilseed oils and flour has been performed for decades, if not millennia. Mechanical extraction, such as with an expeller press, leaves a significant amount of oil in the oil seed flour. For example, Modern methods of chemical extraction using solvents, such as hexane, have been developed to extract a much greater percentage of the oil from flaked and crushed oil seed. These processes come at a higher cost, can involve solvent remaining in the flour and release of solvent intro the environment and involve subjecting the flour to high temperatures which changes the physical and chemical properties of proteins in the flour (denaturation). Processing frequently involves multiple extraction steps, first pressing, then solvent extraction.

### SUMMARY OF THE INVENTION

The present invention provides a process for separating seed oil from the flour that is economical and produces a de-oiled flour that maintains the native form of proteins in the flour. The invention comprises the unique use of a Nutsche filter and at temperatures below where denaturation of proteins occurs to separate at least 97% of the oil from the flour, frequently ≥99%, while maintaining the native form of the proteins in the flour. The process also allows for efficient use of solvent and a very low solvent content in the resulting de-oiled flour.

In one aspect of the invention, a process is provided for separating oil from seeds, flaked or ground or crushed at a temperature range of about 20° C. to about 60° C. to form oil seed flour, extracting oil with solvent using a Nutsche filter at a temperature range of 30-60° C. and a flour to solvent ratio of about 1:1 to 1:4 (w:v). In certain embodiments, the extraction is performed at least twice. In certain embodiments, each extraction is at least 5 minutes. In specific embodiments of the invention, the seeds are flaked or ground at ≤50° C. In other embodiments, the seeds are flaked or ground at about 20° C. In certain embodiments, the extraction is performed at 40-50° C. In some embodiments, the flour to solvent ratio is 1:2-1:3 (w:v). In specific embodiments, the flour to solvent ratio is 1:2 (w:v). In certain embodiments, the solvent is hexane. In other embodiments, the solvent is methyloxylane. In some embodiments, each extraction time is 5-60 minutes. In specific embodiments, each extraction time is 5-15 minutes, in certain embodiments the extraction time is 15 minutes. In some embodiments, extraction is repeated 3-5 times. In certain embodiments, extraction is repeated 4 times. In certain embodiments of the invention, the process further comprises desolventing the de-oiled flour at a temperature of 30-60° C., which step optionally comprises collecting evaporated solvent. In some embodiments, the desolventing temperature is about 45-55° C. In certain embodiments, the desolventing step is performed for 30-90 minutes, in some embodiments 45-75 minutes. In specific embodiments, the desolventing time is 60 minutes. In certain embodiments, the oil seed is rapeseed, which may be canola. In other embodiments, the oil seed is mustard seed. In yet other embodiments the oil seed is sunflower seed.

In another aspect of the invention, a process for preparing oil seed flour containing ≤3% oil is provided. The process comprises flaking or grinding or crushing seeds at a temperature range of about 20° C. to about 60° C. to form a flour, extracting oil from the flour with solvent using a Nutsche filter at a temperature of about 30-60° C. and a ratio of flour to solvent of about 1:1 to about 1:4 (weight to volume), then desolventing the de-oiled flour at a temperature range of about 30-60° C., optionally collecting the evaporated solvent. In certain embodiments the flaking or grinding is at about 20° C. In other embodiments, the flaking or grinding is performed at about 40-50° C. In certain embodiments, the solvent is hexane. In other embodiments, the solvent is methloxylane. In certain embodiments, the extraction step is repeated at least once. In some embodiments, the extraction time is ≥5 minutes. In some embodiments, the extraction step is performed at a temperature range of about 40-50° C. In certain embodiments, the flour to solvent ratio is about 1:1 to about 1:3 (weight to volume). In other embodiments, the flour to solvent ratio is about 1:2 (weight to volume). In certain embodiments, the time of the extraction step is about 5-60 minutes. In some embodiments, each extraction time is about 5-15 minutes. In a specific embodiment, each extraction time is about 15 minutes. In certain embodiments, extraction is repeated 2-6 times. In a specific embodiment, extraction is repeated 4 times. In some embodiments, the desolventing temperature is about 45-55° C. In certain embodiments, the desolventing time is >30 minutes. In other embodiments, the desolventing time is 30-90 minutes. In yet another embodiment, the desolventing time is 45-75 minutes. In some embodiments, the residual solvent content of the seed flour after desolventing is ≤500 ppm. In some embodiments, the residual solvent content in the de-oiled seed flour is ≤200 ppm. In some embodiments, the seed flour protein content is 40-55% after desolventing. In certain embodiments, the seed flour is rapeseed, which may be canola. In another embodiment, the seed flour is mustard seed. In yet another embodiment, the seed flour is sunflower seed.

In yet another aspect, the invention provides a seed flour produced by the processes described above. In certain embodiments, the seed flour is rapeseed or mustard seed. In some embodiments, the seed flour is canola. In specific embodiments of the invention, the de-oiled seed flour comprises 8-25% napin, 10-20% oleosin and 65-85% cruciferin, each substantially in its native protein form. In specific embodiments, the de-oiled seed flour further comprises ≤2% oil, ≤8% moisture, ≤6% phytic acid, ≤4% polyphenol and ≤1% glucosinolates. In another embodiment, the seed flour is mustard seed. In yet another embodiment, the seed flour is sunflower seed. In certain embodiments, the de-oiled seed flour comprises ≤500 ppm solvent; in a more specific embodiment, the de-oiled seed flour comprises ≤100 ppm solvent.

In still another aspect of the invention, a de-oiled canola seed flour is provided comprising 40-55% protein (dry), <1% oil and ≤100 ppm hexane and 10-20% oleosin. In some embodiments, the de-oiled canola seed flour comprises 8-25% napin, 10-20% oleosin and 65-85% cruciferin. In another embodiment, the protein in said de-oiled canola seed flour is substantially in its native form.

In another aspect, the invention provides a de-oiled sunflower seed flour comprising 40-55% protein (dry basis), ≤3% oil and ≤500 ppm solvent. In certain embodiments, the de-oiled sunflower seed flour comprises ≤1% oil. In some embodiments the de-oiled sunflower seed flour comprises ≤100 ppm solvent.

### BRIEF DESCRIPTION OF THE DRAWINGS

FIGS. 1A-1C. Exemplary photos of canola seeds, dry raw flaked canola seeds and de-oiled, desolvented canola flour are shown in FIGS. 1A, 1B and 1C, respectively.

FIG. 2A. The bench top Nutsche Filter used in the Examples described herein.

FIG. 2B. Hexane and oil obtained from six sequential extractions of flaked canola seed flour.

FIG. 2C. Brix refractive index values for hexane (0) and the hexane and oil obtained from six sequential extractions of flaked canola seed flour.

FIG. 3 differential thermogram of the de-oiled flour showing exothermic events at 89° C. and 111° C., corresponding to the thermal transition points of native form napin and cruciferin, respectively.

FIGS. 4A-4C Exemplary photos of sunflower seeds, ground sunflower seed flour and de-oiled sunflower seed flour, respectively.

FIG. 5 Hexane with extracted oil after each of 4 rounds of extraction of sunflower seed flour.

### DETAILED DESCRIPTION OF THE INVENTION

Processes are provided for oil removal from oil seed flour, as well as de-oiled oil seed flour compositions. The processes involve the novel application of a Nutsche filter for the extraction of oil from oil seeds and production of de-oiled seed flour. The de-oiled seed flour is then amenable to further processing to produce protein concentrates or protein isolates as described in co-pending applications filed concurrently with the present application.

Before the present processes and compositions are described, it is to be understood that this invention is not limited to particular methods or compositions described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, some potential and preferred methods and materials are now described. All publications mentioned herein are incorporated herein by reference to disclose and describe the methods and/or materials in connection with which the publications are cited. It is understood that the present disclosure supersedes any disclosure of an incorporated publication to the extent there is a contradiction.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It must be noted that as used herein and in the appended claims, the singular forms “a”, “an”, and “the” include plural referents unless the context clearly dictates otherwise. Thus, for example, reference to “a cell” includes a plurality of such cells and reference to “the induced pluripotent stem cell” includes reference to one or more induced pluripotent stem cells and equivalents thereof, known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### Definitions

The term “about”, particularly in reference to a given quantity, is meant to encompass deviations of plus or minus five percent.

“Extracting” or “extraction” means the removal or separation of one or more component(s) of a multicomponent composition. The concept of extracting oil from oil seeds is well known in the present art.

“Flaking or crushing” is a process of rupturing seed cellular structure to increase surface area of the seeds, facilitating extraction of oil from oil seeds. This may be done through various means, such as a flaking mill.

“Milling” means a process of rupturing seed cellular structure to increase surface area of the seeds, facilitating extraction of oil from oil seeds. This may be done through various means, such as a IKA A10 basic grinder or any regular mill.

“Nutsche Filter” means any of a multitude of commercially available units so named that are designed to separate solid matter from a liquid. These devices can be used in the present invention to remove de-oiled oil seed flour from oil and solvent, such as hexane, ethanol or methyloxylane.

“Desolventing” means the removal of residual solvent, such as hexane, from de-oiled seed flour.

“Substantially in native form” in the context of proteins in in oil seed flour means that the proteins have not been denatured due to, for example, exposure to excessive heat, such that the 3-dimensional structure of the proteins are generally maintained in the form found in the pre-processed seed.

Extracting Oil from Oil Seeds

Processes are provided for removal of oil from oil seeds wherein a Nutsche Filter is employed to extract seed oil from oil seed flour. The oil seed is flaked or ground or crushed to produce a flour, while the temperature during this process is kept below about 60° C. The employment of the Nutsche Filter in this process allows for the separation of oil and extracting solvent, such as hexane, ethanol or methyloxylane, from the oil seed flour in a closed system under conditions that are well controlled. The temperature of the of the extraction process can be maintained a preferred temperature. The extracted oil seed flour can also be desolvented within the device following oil extraction, allowing for recapture of residual solvent for subsequent use and providing a de-oiled flour that is very low in residual solvent.

Oil seeds that may be extracted by the present invention include, without limitation, rapeseed (including canola), sunflower seed, mustard seed, cotton seed, peanut, sesame, safflower, soybean, flax seed, tree nuts, palm kernel and corn. The present invention is amenable to extracting oil from any oil seed amenable to solvent extraction. The precise temperature control provided by the present invention allows for the extraction of oils while maintaining the native structure of the proteins in the resulting de-oiled flour. The de-oiled flour may then be manipulated to increase the protein purity for various uses of such oil seed protein, as further described in patent application concurrently filed with the present application.

The initial production of the oil seed flour to be extracted is subject to common practices in the industry. Flaking or grinding or crushing, depending on the nature of the seed, are viable processes that allow for controlled flour production without subjecting the seed to high temperatures. In certain embodiments, the oil seed flour is initially produced at temperatures below about 60° C. Flaking or grinding may be done at room temperature. In some embodiments, the temperature of the initial oil seed flour production is maintained at a range of 30-60° C.

Nutsche filters are available in a multitude of sizes, with large units capable of handling up to 25 m² of the solvent/flour mixture, thus the present process may be carried out at reasonably large scale. Nutsche filters provide an enclosed environment for extracting oil seed oil, thus minimizing both exposure of the operator to the solvent and loss of solvent in the extraction process. In addition to temperature control, Nutsche filters also have the advantage of being operated under conditions of pressure or vacuum, allowing for further optimization of the extraction process, including vacuum drying to optimize desolventing of the de-oiled flour. Nutsche filters allow for serial/counter current rounds of extraction and resuspension of the flour, and fresh or purified solvent may be introduced, or solvent from a previous extraction may be reused without intervening purification in a counter current mode of operation. The extraction rounds may be anywhere from 1 time to 6 or more. In many applications, 4 rounds of extraction provides a an oil/solvent mixture that is essentially free of suspended solids and results in ≥97% of the oil being extracted from the seed flour, frequently >99%. Extraction of oil seed flour is usual repeated two or more times, frequently 3-5 times. Likewise, extraction times may be varied, depending on desired results. Typically, individual extraction times are 5 minutes or more. Extraction times of 5-60 minutes are useful in the present invention, but may be as short as 5-15 minutes. In some cases, 15 minutes extraction time is optimum.

Various liquid solvents may be employed in the present invention, including hexane, ethanol, methyloxylane, pentane, heptane, propane, super critical CO2, liquid CO2, and octane. The current preferred solvents for extraction of oil seeds, in particular for extraction of oil and production of oil seed protein for use as food are hexane and methyloxylane. The present process allows for minimum loss of solvent, making it safer for operators and the environment. Minimization of solvent also reduces costs, as solvent can be an expensive component of the extraction process.

If the native form of the proteins in the de-oiled flour is desired to be maintained, the temperature during the extraction process should be maintained below about 60° C. to avoid denaturation by heat. The retention of protein native form can provide unique properties of the resulting protein in the de-oiled flour. Maintaining a temperature of about 40-50° C. during the extraction process allows for reasonable miscibility of the seed oil into the solvent without risking denaturing of the proteins in the flour.

The ratio of oil seed flour to solvent may be varied, depending on the nature of the seed and the desired extraction results. Typically, a flour to solvent ratio of between about 1:1 to 1:4 (weight:volume or w:v) is used. In many instances, a flour to solvent ratio of 1:2 (w:v) is sufficient to extract ≥97% of the oil from the seed flour, but even 1:1 can give a similar result.

### De-Oiled Oil Seed Flour

In addition to the extraction of the oil, the present invention provides for the desolventing of the de-oiled flour following extraction. As mentioned, the closed system of the Nutsche filter allows for the removal and recapture of solvent in the de-oiled flour. Typically, the desolventing is done at a temperature of 30-60° C. A desolventing temperature of 45-55° C. allows for good evaporation of the solvent without risking denaturation of the protein; the higher end of this range providing for even lower amounts of solvent remaining in the de-oiled flour. Desolventing is typically carried out for between 30 and 90 minutes. In some cases, 45-75 minutes is sufficient to allow good removal of solvent from the de-oiled flour; 60 minutes desolventing time is frequently sufficient to reduce solvent content in the flour to 60-100 ppm.

The processes of the present invention consistently produce a de-oiled seed flour with a protein content of 40-55% (dry basis or DB) protein, containing ≤3% oil and 60-500 ppm solvent when using hexane or methyloxylane. Furthermore, the protein in the de-oil seed flour is maintained substantially in its native form, due to the controlled temperatures.

The de-oiled oil seed flour produced by the present process is perfectly amenable to subsequent processing to a protein concentrate or a protein isolate. The protein concentrates and protein isolates derived therefrom have been found to have desirable attributes with regard to foaming, gelation and emulsion formation, as described in concurrently filed patent applications.

### Exemplary Non-Limiting Aspects of the Disclosure

Aspects, including embodiments, of the present subject matter described above may be beneficial alone or in combination, with one or more other aspects or embodiments. Without limiting the foregoing description, certain non-limiting aspects of the disclosure numbered 1-63 are provided below. As will be apparent to those of skill in the art upon reading this disclosure, each of the individually numbered aspects may be used or combined with any of the preceding or following individually numbered aspects. This is intended to provide support for all such combinations of aspects and is not limited to combinations of aspects explicitly provided below:
1. A process for extracting oil from oil seeds, comprising:
   a) Flaking or grinding or crushing seeds at a temperature range of about 20° C. to 60° C. to form a flour,
   b) using a Nutsche Filter to extract oil from seed flour with solvent, comprising the parameters of:
      i) maintaining a temperature of about 30-60° C.,
      ii) using a flour to solvent ratio of from 1:1 to 1:4 (w/v),
   whereby oil is separated from the seed flour.
2. The process of Aspect 1, wherein the extraction of the flour is repeated ≥2 times.
3. The process of any of Aspects 1-2, wherein each extraction time is ≥5 minutes.
4 The process of any of Aspects 1-3, wherein step a) is performed at a temperature ≤50° C.
5. The process of any of Aspects 1-4, wherein the temperature of step a) is ≤20° C.
6. The process of any of Aspects 1-5, wherein the temperature of step b) is maintained at a range of 40-50° C.
7. The process of any of Aspects 1-6, wherein the flour to solvent ratio is from 1:1 to 1:3.
8. The process of any of Aspects 1-7, wherein the flour to solvent ratio is 1:2.
9. The process of any of Aspects 1-8, wherein the solvent is hexane.
10. The process of any of Aspects 1-8, wherein the solvent is methyloxylane.
11. The process of any of Aspects 1-10, wherein the wash time is 5-60 minutes.
12. The process of any of Aspects 1-11, wherein each extraction time is 5-15 minutes.
13. The process of any of Aspects 1-12, wherein each extraction time is 15 minutes.
14. The process of any of Aspects 1-13, wherein each extraction is repeated 3-5 times.
15. The process of any of Aspects 1-14, wherein each extraction is repeated 4 times.
16. The process of any of Aspects 1-15, further comprising:
   c) desolventing the de-oiled flour, comprising the parameters of:
      i) temperature of about 30-60° C.,
      ii) optionally, collecting evaporated hexane.
17. The process of Aspect 16, wherein the desolventing temperature is about 45-55° C.
18. The process of any of Aspects 16-17, wherein the desolventing time is 30-90 minutes.
19. The process of any of Aspects 16-18, wherein the desolventing time is 45-75 minutes.
20. The process of any of Aspects 16-19, wherein the desolventing time is 60 minutes.
21. The process of any of Aspects 1-20, wherein the oil seed is rapeseed or mustard.
22. The process of Aspect 21, wherein the oil seed is canola.
23. The process of any of Aspects 1-20, wherein the oil seed is sunflower.
24. A process for preparing oil seed flour that contains ≤3% oil, comprising:
   a) Flaking or grinding or crushing seeds at a temperature range of about 20° C. to 60° C. to form a flour,
   b) extracting oil from the seed flour with solvent using a Nutsche Filter, comprising the parameters of:
      i) maintaining a temperature of about 30-60° C.,
      ii) using a flour to solvent ratio of from 1:1 to 1:4 (w/v),
   c) desolventing the de-oiled flour, comprising the parameters of:
      i) a temperature of about 30-60° C.,
      ii) optionally, collecting evaporated solvent.
25. The process of Aspect 24, wherein step a) is performed at about 20° C.
26. The process of Aspect 24, wherein step a) is performed at a range of 40-50° C.
27. The process of any of Aspects 24-26, wherein the solvent is hexane.
28. The process of any of Aspects 24-26, wherein the solvent is methyloxylane.
29. The process of any of Aspects 24-28, wherein the extraction of step b) is repeated at least once.
30. The process of any of Aspects 24-29, wherein each extraction time of step b) is ≥5 minutes.
31. The process of any of Aspects 24-30, wherein the temperature of step b) is maintained at a range of 40-50° C.
32. The process of any of Aspects 24-31, wherein the flour to solvent ratio is from 1:1 to 1:3.
33. The process of any of Aspects 24-32, wherein the flour to solvent ratio is 1:2.
34. The process of any of Aspects 24-33, wherein each extraction time is 5-60 minutes.
35. The process of any of Aspects 24-34, wherein each extraction time is 5-15 minutes.
36. The process of any of Aspects 24-35, wherein each extraction h time is 15 minutes.
37. The process of any of Aspects 24-36, wherein the extraction is repeated 2-6 times.
38. The process of any of Aspects 24-37, wherein the extraction is repeated 4 times.
39. The process of any of Aspects 24-38, wherein the desolventing temperature is about 45-55° C.
40. The process of any of Aspects 24-39, wherein the desolventing time is >30 minutes.
41. The process of any of Aspects 24-40, wherein the desolventing time is 30-90 minutes.
42. The process of any of Aspects 24-41, wherein the desolventing time is 45-75 minutes.
43. The process of any of Aspects 24-42, wherein the residual solvent content is less than 500 ppm after desolventing.
44. The process of any of Aspects 24-43, wherein the residual solvent content is less than 200 ppm after desolventing.
45. The process of any of Aspects 24-44, wherein the seed flour protein content is 40-55% after desolventing.
46. The process of any of Aspects 24-45, wherein the oil seed is rapeseed or mustard.
47. The process Aspect 46, wherein the oil seed is canola.
48 The process of any of Aspects 24-44, wherein the oil seed is sunflower.
49. A de-oiled seed flour produced by the process of any of Aspects 24-45.
50. The seed flour of Aspect 49, wherein the oil seed is rapeseed or mustard.
51. The seed flour of Aspect 50, wherein the oil seed is canola.
52. The seed flour of any of Aspects 50-51, wherein said de-oiled seed flour comprises 8-25% napin, 10-20% oleosin and 65-85% cruciferin, each substantially in their native protein form.
53. The seed flour of Aspect 52, further comprising:
   a) ≤2% oil,
   b) ≤8% moisture,
   c) ≤6% phytic acid,
   d) ≤4% polyphenol, and
   e) ≤1% glucosinolates.
54 The seed flour of Aspect 49, Wherein the oil seed is sunflower.
55. The seed flour of any of Aspects 49-54, wherein the protein in the seed flour is substantially in its native form.
56. The seed flour of any of Aspects 49-55 comprising ≤500 ppm solvent.
57. The seed flour of Aspect 56 comprising ≤100 ppm solvent.
58. A de-oiled canola seed flour comprising 40-55% protein (dry), ≤1% oil and ≤100 ppm hexane, wherein said canola seed flour comprises 10-20%. oleosin.
59. The de-oiled canola seed flour of Aspect 58, wherein said protein comprises 65-85% cruciferin, 10-20% oleosin and 8-25% napin.
60. The de-oiled canola seed flour of any of Aspects 58-59, wherein said protein is substantially in its native form.
61. A de-oiled sunflower seed flour comprising 40-55% protein (dry), ≤3% oil and ≤500 ppm solvent.
62. The de-oiled sunflower seed flour of Aspect 61, comprising ≤1% oil.
63. The de-oiled sunflower seed flour of any of Aspects 61-62 comprising ≤100 ppm solvent.

### EXAMPLES

The following examples are put forth so as to provide those of ordinary skill in the art with a complete disclosure and description of how to make and use the present invention and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, temperature is in degrees Centigrade, and times are in minutes.

All publications and patent applications cited in this specification are herein incorporated by reference as if each individual publication or patent application were specifically and individually indicated to be incorporated by reference.

The present invention has been described in terms of particular embodiments found or proposed by the present inventor to comprise preferred modes for the practice of the invention. It will be appreciated by those of skill in the art that, in light of the present disclosure, numerous modifications and changes can be made in the particular embodiments exemplified without departing from the intended scope of the invention. All such modifications are intended to be included within the scope of the appended claims.

### Example 1: Extraction of Oil from Canola Seeds

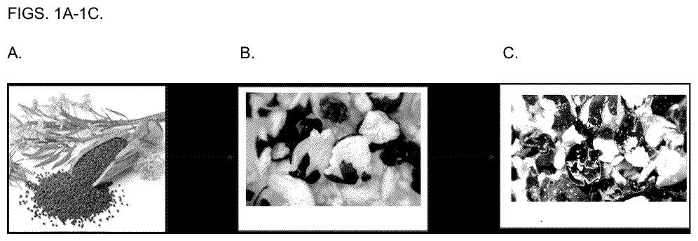

Canola oil seeds were flaked at a low temperature <50° C. FIG. 1 pictures canola seeds, flaked canola seed flour and de-oiled flaked canola seed flour in Figures A, B and C, respectively.

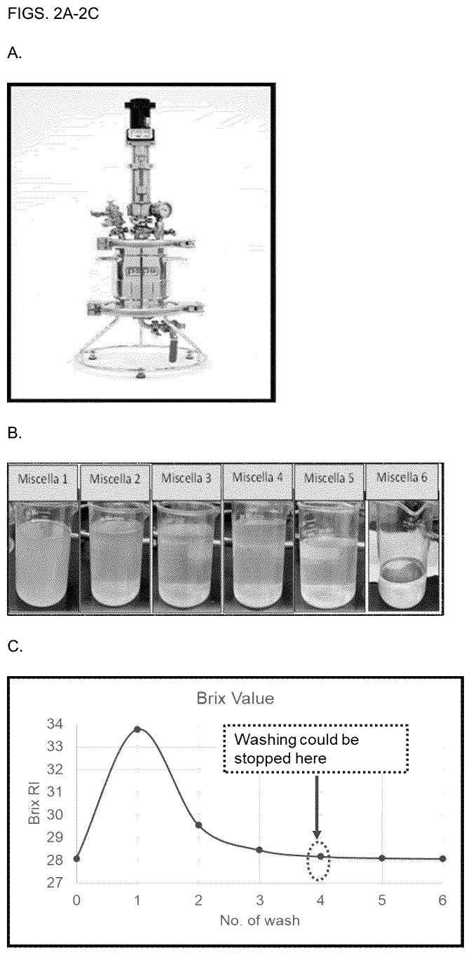

Oil was extracted from the flaked canola seeds using a Nutsche filter (NF). The flaked canola seed flour was mixed with hexane in a ratio of 1:3 (w:v) and 6 cycles of extraction were performed at a maintained temperature of 50° C.; each extraction lasted 45 minutes. FIG. 2A shows the bench top Nutsche filter used for this example. FIG. 2B shows the hexane with extracted oil after each of 6 rounds of extraction.

This is novel NF based oil separation process from canola oil seeds, specifically flaked canola oil seeds, and this is the first time this technology has been utilized for maximum oil extraction, low remaining ppm levels of solvent in the canola flour and maintaining the integrity of canola proteins in the canola flour. FIG. 2C shows the Brix refractive index (Brix RI) for hexane (at point 0) and for each of the 6 extraction cycles. Based on the refractive index returning essentially to baseline after cycle 4, it was determined that oil separation ≥99% could be obtained in a minimum of 4 cycles.

### Example 2: Optimization of Extraction of Oil from Canola Seeds

Table 1 shows the results of varying parameters of the extraction process applied to canola seed.

TABLE 1

| | | | | Protein | |
|---|---|---|---|---|---|
| Fixed extraction | Varied extraction | | Oil | content | Hexane |
| parameters | parameters | | Remained | (%) | (ppm) |
| Flour to hexane | Extraction | | ≤1% | ≥50% DB | NA |
| ratio: 1:3 | temperature | | ≤1% | ≥50% DB | |
| Time 45 min | 50° | C. | | | |
| | 55° | C. | | | |
| Flour to hexane | Extraction Time | | ≤1% | ≥50% DB | NA |
| ratio: 1:3 | 15 | min | ≤1% | ≥50% DB | |
| Extraction | 30 | min | ≤1% | ≥50% DB | |
| temperature: 50° C. | 45 | min | | | |
| Extraction | Flour to hexane | | ≤1% | ≥50% DB | NA |
| temperature: 50 C. | ratio | | ≤1% | ≥50% DB | |
| Extraction time: 15 | 1:1 | (w/v) | ≤1% | ≥50% DB | |
| min | 1:2 | (w/v) | | | |
| | 1:3 | (w/v) | | | |
| Extraction | No. of hexane | | ≤1% | ≥50% DB | NA |
| temperature: 50° C. | cycles | | ≤1% | ≥50% DB | |
| Extraction time: 15 | 4 | (w/v) | | | |
| min | 6 | (w/v) | | | |
| 1:2 flour to solvent | | | | | |
| (w/v) | | | | | |
| Extraction | Desoventing | | ≤1% | ≥50% DB | 130-160 |
| temperature: 50° C. | temperature | | ≤1% | ≥50% DB | 100-120 |
| Extraction time: 15 | 45° | C. | ≤1% | ≥50% DB | 70-100 |
| min | 50° | C. | | | |
| 1:2 flour to solvent | 55° | C. | | | |

(w/v)
4 washes

From the variations in parameters, we determined that the use of the NF based process for flaked canola oil seeds using hexane at an extraction temperature of about 50 enables us to remove ≥99% of the oil with no more than a 1:1 (w:v) flour to hexane ratio in about 4 extraction cycles, providing a de-oiled canola seed flour having greater than 50% protein (dry basis) and, after desolventing at 55° C. for 15 minutes, leaving just about 60-100 ppm hexane in the de-oiled flour.

### Example 3: Recycling Solvent for Oil Separation

Using the optimized parameters from Example 2, we explored parameters of using different fresh, purified or reused hexane for the oil extraction of flaked canola seed flour. As shown in Table 2, similar quality of de-oiled protein was retrieved, regardless of whether the hexane used was fresh, purified or reused without purification.

TABLE 2

| | | No. of | Protein |
|---|---|---|---|
| | Method of Reuse | extractions | content (%) |
| 1 | Use the purified hexane for all the washes | 4 | 40-50 |
| 2 | Reuse the used hexane (as is) from | 4 | 40-50 |
| | previous process (without purification) | | |
| 3 | Use fresh solvent for 1 wash and for the | 4 | 40-50 |
| | rest reuse the hexane as is from previous | | |
| | extraction | | |

### Example 4: Maintained Integrity of Native Protein Form in De-Oiled Canola Flour

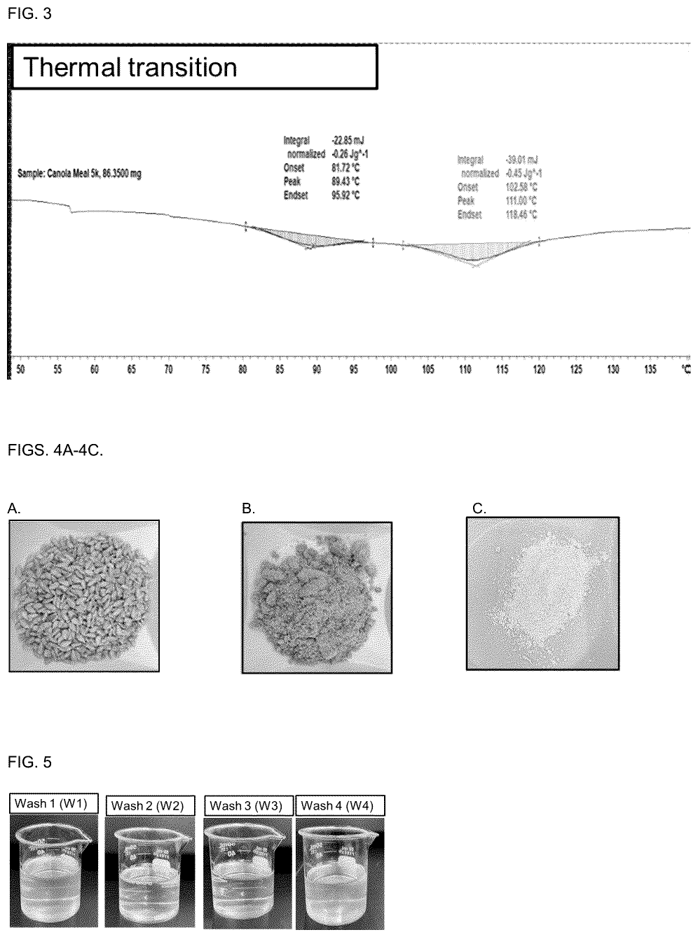

Differential scanning calorimetry was performed on de-oiled protein obtained from the process of Example 2. FIG. 3 shows a differential thermogram of the de-oiled flour showing exothermic events at 89° C. and 111° C., corresponding to the thermal transition points of native form napin and cruciferin, respectively. These data show that the native form of the canola proteins is maintained through the extraction process described herein.

### Example 5: Extraction of Oil from Sunflower Seeds

Sunflower seeds were ground in a mill at room temperature to form a sunflower seed flour. The sunflower seed flower was extracted with hexane at a flour to hexane ratio of about 1:2 (w:v) in a Nutsche filter at an extraction temperature of about 50° C. and an extraction time of 15 minutes. FIGS. 4A, B and C show sunflower seeds, ground sunflower seed flour and de-oiled sunflower seed flour, respectively. The extraction cycle was repeated 4 times. FIG. 5 shows the hexane with extracted oil after each of 4 rounds of extraction. Table 3 shows the dry matter (DM) content and Brix refractive index of the hexane and oil after four sequential extraction cycles, showing that ≥99% oil extraction was complete after 3-4 cycles.

TABLE 3

| Wash | Hx (mL) | DM (%) | Brix RI |
|---|---|---|---|
| W0 | 0 | — | 26.1 |
| W1 | 400 | 25.5 | 37.6 |
| W2 | 400 | 8.8 | 29.9 |
| W3 | 400 | 0.6 | 27.1 |
| W4 | 400 | 0.2 | 26.2 |

Sunflower seed flour was desolventized at 55° C. for 30 minutes. The de-oiled sunflower seed flour obtained had ≤1% oil, about 54% protein (dry basis) and 60-100 ppm hexane.

1. A process for extracting oil from oil seeds, comprising:
a) Flaking or grinding or crushing seeds at a temperature range of about 20° C. to 60° C. to form a flour,
b) using a Nutsche Filter to extract oil from seed flour with solvent, comprising the parameters of:
i) maintaining a temperature of about 30-60° C.,
ii) using a flour to solvent ratio of from 1:1 to 1:4 (w/v),
whereby oil is separated from the seed flour.

2. The process of claim 1, wherein the extraction step b) is repeated ≥2 times.

3. The process of claim 1, wherein each extraction time of step b is ≥5 minutes.

4. The process of claim 1, wherein step a) is performed at a temperature ≤50° C.

5. The process of claim 1, wherein the extraction time of step b) is 5-15 minutes.

6. The process of claim 4, wherein the temperature of step a) is maintained at a range of 40-50° C.

7. The process of claim 1, wherein the flour to solvent ratio of step b), ii) is from 1:1 to 1:3.

8. The process of claim 1, wherein the flour to solvent ratio of step b), ii) is 1:2.

9. The process of claim 1, wherein the solvent is hexane.

10. The process of claim 1, wherein the solvent is methyloxylane.

11. (canceled)

12. The process of claim 2, wherein each extraction time is 5-15 minutes.

13. The process of claim 2, wherein each extraction time is 15 minutes.

14. The process of claim 2, wherein each extraction is repeated 3-5 times.

15. The process claim 2, wherein each extraction is repeated 4 times.

16. The process of claim 1, further comprising:
c) desolventing the de-oiled flour, comprising the parameters of:
i) temperature of about 30-60° C.,
ii) optionally, collecting evaporated hexane.

17. The process of claim 16, wherein the desolventing temperature is about 45-55° C.

18. The process of claim 16, wherein the desolventing time is 30-90 minutes.

19. The process of claim 16, wherein the desolventing time is 45-75 minutes.

20. The process of claim 16, wherein the desolventing time is 60 minutes.

21. The process of claim 1, wherein the oil seed is rapeseed or mustard.

22. The process of claim 21, wherein the oil seed is canola.

23. The process of claim 1, wherein the oil seed is sunflower.

24.-42. (canceled)

43. The process of claim 16, wherein the residual solvent content of the de-oiled flour is less than 500 ppm after desolventing.

44. The process of claim 43, wherein the residual solvent content of the de-oiled flour is less than 200 ppm after desolventing.

45. The process of claim 16, wherein the seed flour protein content is 40-55% after desolventing.

46. The process of claim 16, wherein the oil seed is rapeseed or mustard.

47. The process claim 46, wherein the oil seed is canola.

48. The process of claim 16, wherein the oil seed is sunflower.

49. A de-oiled seed flour produced by the process of claim 1 or 16.

50. The seed flour of claim 49, wherein the oil seed is rapeseed or mustard.

51. The seed flour of claim 50, wherein the oil seed is canola.

52. The seed flour of claim 51, wherein said de-oiled seed flour comprises 8-25% napin, 10-20% oleosin and 65-85% cruciferin, each substantially in their native protein form.

53. The seed flour of claim 52, further comprising:
a) ≤2% oil,
b) ≤8% moisture,
c) ≤6% phytic acid,
d) ≤4% polyphenol, and
e) ≤1% glucosinolates.

54. The seed flour of claim 49, Wherein the oil seed is sunflower.

55. The seed flour of claim 49, wherein the protein in the seed flour is substantially in its native form.

56. The seed flour of claim 49 comprising ≤500 ppm solvent.

57. The seed flour of claim 56 comprising ≤100 ppm solvent.

58.-63. (canceled)
